(19) United States
(12) Patent Application Publication
(10) Pub. No.: US 2020/0036037 A1
(43) Pub. Date: Jan. 30, 2020

(54) Electrodes Comprising Metal Introduced Into a Solid-State Electrolyte

(71) Applicant: Siemens Aktiengesellschaft, München (DE)

(72) Inventors: Ralf Krause, Herzogenaurach (DE); Christian Reller, Minden (DE); Günter Schmid, Hemhofen (DE); Bernhard Schmid, Erlangen (DE); Dan Taroata, Erlangen (DE)

(73) Assignee: Siemens Aktiengesellschaft, München (DE)

(21) Appl. No.: 16/491,465

(22) PCT Filed: Feb. 2, 2018
(86) PCT No.: PCT/EP2018/052656

§ 371 Date: Sep. 5, 2019

(30) Foreign Application Priority Data
Mar. 9, 2017 (DE) 10 2017 203 900.0

(51) Int. Cl. H01M 10/0562; C25B 11/03; C25B 1/14; C25B 11/04; C25B 3/04

(52) U.S. Cl. CPC H01M 10/0562; C25B 11/035; C25B 3/04; C25B 11/04; C25B 1/14

(57) ABSTRACT

Various embodiments include an electrode comprising: a solid electrolyte; and a metal M selected from the group of metals consisting of: Cu, Ag, Au, and Pd. The solid electrolyte is selected from the group consisting of: germanium disulfide, germanium diselenide, germanium sulfide, germanium selenide, tungsten trioxide, silver(I) sulfide, silicon dioxide, yttrium-stabilized zirconium(IV) oxide, polysulfone, polybenzoxazole, and polyimide.

### CROSS-REFERENCE TO RELATED APPLICATIONS

This application is a U.S. National Stage Application of International Application No. PCT/EP2018/052656 filed Feb. 2, 2018, which designates the United States of America, and claims priority to DE Application No. 10 2017 203 900.0 filed Mar. 9, 2017, the contents of which are hereby incorporated by reference in their entirety.

### TECHNICAL FIELD

The present disclosure relates to electrolysis. Various embodiments may include an electrode comprising a solid-state electrolyte or solid electrolyte and a metal M, e.g., a gas diffusion electrode in the one-stage electrochemical CO₂/CO to CO or hydrocarbon reduction.

### BACKGROUND

The combustion of fossil fuels currently covers about 80% of global energy demand. These combustion processes emitted about 34 032.7 million metric tons of carbon dioxide (CO₂) globally into the atmosphere in 2011. This release is the simplest way of disposing of large volumes of CO₂ as well (brown coal power plants exceeding 50 000 t per day). Discussion about the adverse effects of the greenhouse gas CO₂ on the climate has led to consideration of reutilization of CO₂. In thermodynamic terms, CO₂ is at a very low level and can therefore be reduced again to usable products only with difficulty.

In nature, CO₂ is converted to carbohydrates by photosynthesis. This process, which is divided up into many component steps over time and spatially at the molecular level, is copiable on the industrial scale only with great difficulty. The more efficient route at present compared to pure photocatalysis is the electrochemical reduction of the CO₂. As opposed to light energy in photosynthesis, CO₂ is converted in this process with supply of purely electrical energy which can be obtained from renewable energy sources such as wind or solar to a higher-energy product (such as CO, CH₄, C₂H₄, C₂H₅OH, etc.). The amount of energy required in this reduction corresponds ideally to the energy of combustion of the fuel and should e.g. come solely from renewable sources. However, overproduction of renewable energies is not continuously available, but rather at present only in periods with intense insolation and strong wind.

It is therefore viable to use CO₂ as a carbon source for the electrochemical production of higher-value products. By contrast with the hydrogen electrolyzers, the separation between products and reactants in the case of CO₂ electrolyzers is much more complex since both products and reactants are in gaseous form. Moreover, particularly in aqueous media, there is always a competing reaction between the formation of hydrogen and the intended CO₂ reduction products, e.g. CO or ethylene, ethanol.

Silver-containing gas diffusion electrodes are used as what are called oxygen-depolarized cathodes in chloralkali electrolysis in order to suppress hydrogen formation by supply of gaseous oxygen at the cathode. This “integrated fuel cell” lowers the energy demand of chloralkali electrolysis by about 30%.

H₂O+O₂+2e⁻→2OH⁻

This shows that such electrodes already have a relatively high overpotential for hydrogen formation (HER; hydrogen evolution reaction). Therefore, these electrodes can also be used as gas diffusion electrodes for the one-stage direct electrochemical reduction of CO₂ to CO in a wide variety of different cell concepts (e.g. CO₂ flowing past, CO₂ flowing by, PEM (polymer electrolyte membrane), half-PEM, with or without electrolyte gap concepts). At current densities above about 200-300 mA/cm², however, a significant HER is observed.

In the literature (S. S. Neubauer, R. K. Krause, B. Schmid, D. M. Guldi, G. Schmid; “Overpotentials and Faraday Efficiencies in CO₂ Electrocatalysis—the Impact of 1-Ethyl-3-Methylimidazolium Trifluoromethanesulfonate”; Adv. Energy Mater. 2016, 1502231) and literature cited therein, ionic liquids are used to obtain a cocatalytic effect between silver electrode and ionic liquid that lowers the overpotential of the CO₂ reduction and increases that of the HER. However, it has been found that the ionic liquids are in some cases unstable, especially at high current densities, and the cations thereof can be fully hydrolyzed (Sebastian S. Neubauer, Bernhard Schmid, Christian Reller, Dirk M. Guldi and Gunter Schmid; “Alkalinity Initiated Decomposition of Mediating Imidazolium Ions in High Current Density CO₂ Electrolysis”; ChemElectroChem 2016, 3, 1-9).

### SUMMARY

It has been found that silver electrodes anoxidized with oxygen plasma show significantly elevated selectivity of CO formation in the electrochemical CO₂ reduction. However, this effect is not stable over long periods since the silver oxide formed can be readily reduced back to silver during the electrolysis process. The teachings of the present disclosure describe effective electrodes having long-term stability, especially for a product-selective electrolytic reduction of CO₂.

For example, some embodiments include an electrode comprising a solid electrolyte and a metal M, wherein the metal M is selected from Cu, Ag, Au, Pd, and mixtures and/or alloys thereof, wherein the solid electrolyte is selected from germanium disulfide, germanium diselenide, germanium sulfide, germanium selenide, tungsten trioxide, silver(I) sulfide, silicon dioxide, yttrium-stabilized zirconium(IV) oxide, polysulfone, polybenzoxazole and/or polyimide.

In some embodiments, the electrode is a gas diffusion electrode.

In some embodiments, the solid electrolyte is selected from germanium disulfide, germanium diselenide, germanium sulfide and/or germanium selenide.

In some embodiments, the metal M has a solubility in the solid electrolyte at a temperature of 25° and standard pressure of at least 0.1 mol/L.

In some embodiments, the solid electrolyte stabilizes a cation of the metal M, e.g., M⁺.

As another example, some embodiments include a method of electrolysis of CO₂ and/or CO, wherein an electrode as described above is used as cathode. As another example, some embodiments include use of an electrode as described above in the electrolysis of CO₂ and/or CO.

As another example, some embodiments include a process for producing an electrode comprising a solid electrolyte and a metal M, wherein the metal M is selected from Cu, Ag, Au, Pd, and mixtures and/or alloys thereof, wherein the metal M is applied to and diffuses into the solid electrolyte, or wherein the solid electrolyte is added to a salt solution of the metal M and the metal M is deposited on and diffuses into the solid electrolyte by reduction, or wherein a solid electrolyte is deposited onto an electrode comprising the metal M, or wherein the solid electrolyte is deposited onto particles of the metal M and the particles are processed further to give an electrode, wherein the solid electrolyte is selected from germanium disulfide, germanium diselenide, germanium sulfide, germanium selenide, tungsten trioxide, silver(I) sulfide, silicon dioxide, yttrium-stabilized zirconium(IV) oxide, polysulfone, polybenzoxazole and/or polyimide.

In some embodiments, the solid electrolyte is deposited on particles of the metal M and the particles are processed further to give an electrode, wherein the particles of the metal M are nano- and/or microparticles.

In some embodiments, the particles on which the solid electrolyte has been deposited are heat-treated.

In some embodiments, the metal M is applied to and diffuses into the solid electrolyte, or wherein the solid electrolyte is added to a salt solution of the metal M and the metal M is deposited on and diffuses into the solid electrolyte by reduction, wherein the inward diffusion is effected by the action of heat and/or light.

As another example, some embodiments include an electrolysis cell comprising an electrode as described above. As another example, some embodiments include an electrolysis system comprising an electrode as described above.

### BRIEF DESCRIPTION OF THE DRAWINGS

The appended drawings illustrate embodiments of the teachings of the present disclosure and impart further understanding without limiting the scope thereof. In connection with the description, they serve to elucidate concepts and principles of the teachings. Other embodiments and many of the advantages mentioned are apparent with regard to the drawings. The elements of the drawings are not necessarily shown true to scale with respect to one another. Elements, features and components that are the same, have the same function and the same effect are each given the same reference numerals in the figures of the drawing, unless stated otherwise.

FIG. 1 shows an illustrative diagram of a possible construction of an electrolysis cell in one embodiment incorporating teachings of the present disclosure.

FIG. 2 shows a further illustrative diagram of a possible construction of an electrolysis cell in one embodiment incorporating teachings of the present disclosure.

FIG. 3 shows a third illustrative diagram of a possible construction of an electrolysis cell in one embodiment incorporating teachings of the present disclosure.

FIG. 4 shows a fourth illustrative diagram of a possible construction of an electrolysis cell in one embodiment incorporating teachings of the present disclosure.

FIG. 5 shows an illustrative configuration of an electrolysis system for CO₂ reduction incorporating teachings of the present disclosure.

FIG. 6 shows a further illustrative configuration of an electrolysis system for CO₂ reduction incorporating teachings of the present disclosure.

FIG. 7 shows a schematic detail from a gas diffusion electrode of the invention as an example of an electrode incorporating teachings of the present disclosure.

### DETAILED DESCRIPTION

At the start of the century, what is called CBRAM (conductive bridging RAM) memory was developed in the semiconductor industry. In this context, silver- or copper-containing solid-state electrolyte systems are known from the semiconductor industry, employed in CBRAM memory. It has been found that elemental silver—or copper somewhat less readily—dissolves in glasses as solid electrolyte matrix, for example of germanium chalcogenides such as germanium disulfide, germanium diselenide, germanium sulfide or germanium selenide, but also tungsten oxide, even in the event of slight heating or incidence of light at room temperature—for example even normal room lighting is sufficient. A similar effect is observed for copper on dissolution in a silicon dioxide matrix.

In some embodiments, such systems can be embedded, e.g. in electrodes for one-stage catalytic CO₂ reduction to CO and/or hydrocarbons and these materials can be used in a simple manner to produce electrodes, especially for CO₂ reduction. By virtue of the solid electrolyte environment, it is possible here to stabilize metal cations in the solid electrolyte matrix, such that catalytic CO₂ reduction is enabled.

In some embodiments, an electrode comprises a solid electrolyte and a metal M, wherein the metal M is selected from Cu, Ag, Au, Pd, and mixtures and/or alloys thereof. In some embodiments, a method of electrolysis of CO₂ and/or CO, uses the electrode described herein, e.g., in the electrolysis of CO₂ and/or CO.

In some embodiments, there is a process for producing an electrode comprising a solid electrolyte and a metal M, wherein the metal M is selected from Cu, Ag, Au, Pd, and mixtures and/or alloys thereof, wherein the metal M is applied to and diffuses into the solid electrolyte, or wherein the solid electrolyte is added to a salt solution of the metal M and the metal M is deposited on and diffuses into the solid electrolyte by reduction, or wherein a solid electrolyte is deposited onto an electrode comprising the metal M, or wherein the solid electrolyte is deposited onto particles of the metal M and the particles are processed further to give an electrode. In some embodiments, an electrolysis cell comprises the electrode described herein.

Unless defined differently, the technical and scientific expressions used herein have the same meaning as commonly understood by a person skilled in the art in the technical field of the invention.

“Hydrophobic” in the context of the present disclosure is understood to mean water-repellent. Hydrophobic pores and/or channels are thus those that repel water. More particularly, hydrophobic properties are associated with substances or molecules having nonpolar groups. “Hydrophilic”, by contrast, is understood to mean the ability to interact with water and other polar substances.

In the present disclosure, statements of amount are based on % by weight, unless stated otherwise or apparent from the context.

A solid electrolyte (also called solid-state electrolyte) in this context is a solid in which at least one kind of ion is mobile in such a way that an electrical current carried by these ions can flow. In the present disclosure, the solid electrolyte serves primarily as matrix for the metal M. It is not impossible that the solid electrolyte at the same time also has electronic conductivity, but the solid electrolyte need not have electronic conductivity and, in particular embodiments, has essentially no electronic conductivity or even no electronic conductivity at a temperature of, for example, 200° C. or less, for example 100° C. or less, for example 50° C. or less, for example at room temperature of 20-25° C., e.g. 22° C. In some embodiments, the solid electrolyte is hydrophilic, or at least its surface is hydrophilic. In some embodiments, the solid electrolyte is nonhydrolyzable or at least essentially nonhydrolyzable.

In some embodiments, use is made essentially not of the ion conductivity of the solid electrolyte but rather of the property of being able to provide a matrix for the metal M, in that the metal M can diffuse into the matrix of the solid electrolyte. In some embodiments, an electrode or electrolysis cell of the invention is used in such a way that it essentially does not make use of the electrolytic properties of the solid electrolyte, similarly to the case of the abovementioned CBRAMs.

The nature of the solid electrolyte is not particularly restricted here. Nor is it impossible that a solid electrolyte is also itself converted, for example reduced, in the course of use of the electrode, for example in a reduction reaction in which the electrode is used as cathode. In some embodiments, the solid electrolyte is selected from glasses, ceramics, ionic crystals and/or polymers. The glasses, ceramics, ionic crystals and polymers are not particularly restricted here provided that they are solid electrolytes. Examples of glasses here are, for example, germanium disulfide, germanium diselenide, germanium sulfide, germanium selenide, tungsten trioxide, silicon dioxide, etc. One example of a ceramic is yttrium-stabilized zirconium(IV) oxide, which is also employed in lambda probes for example. Useful ionic crystals include, for example, α-AgI, and also, for example, fast ion conductors such as Ag₂HgI₄, RbAg₄I₅, Ag₂₆I₁₈W₄O₁₆, Ag₁₆I₁₂P₂O₇, Ag₈I₄V₂O₇, Ag₅IP₂O₇, or copper(I) compounds such as compounds of the Cu₆PS₅Hal type with Hal=Cl, Br, I. Thus polymers come, for example, polybenzoxazoles, polyformalde-hydes, polysulfones and/or polyimides, e.g. polysulfone, polybenzoxazole and/or polyimide into question. In some embodiments, the solid electrolytes, for example the polymers or polymeric systems as solid electrolyte, can form coordinate and/or ionic bonds to the metal M, for example silver.

In some embodiments, the solid electrolyte includes a chalcogenide, for example a compound such as, for instance, germanium selenide, germanium diselenide, germanium sulfide, germanium disulfide, germanium telluride, silicon selenide, silicon sulfide, silicon dioxide, lead sulfide, lead selenide, lead telluride, tin sulfide, tin selenide, tin telluride, zinc sulfide, zinc selenide, tungsten trioxide, cadmium sulfide, cadmium selenide or mixtures of the compounds, e.g. germanium disulfide, germanium diselenide, germanium sulfide and/or germanium selenide, especially e.g. germanium disulfide, germanium diselenide. Further preferred as well as germanium disulfide, germanium diselenide, germanium sulfide and germanium selenide are also tungsten trioxide, silver(I) sulfide, silicon dioxide and/or yttrium-stabilized zirconium(IV) oxide, and/or an oxygen-containing polymer, e.g. polysulfone, polybenzoxazole and/or polyimide. Especially preferred are germanium disulfide, germanium diselenide, germanium sulfide and/or germanium selenide, especially germanium disulfide, germanium diselenide.

In some embodiments, the solid electrolyte serves as matrix for the metal M, where the metal M, e.g. silver, can diffuse into the solid electrolyte and may be “absorbed” thereby; in other words, in the case of any supply of energy, there is active uptake of the metal M by the solid electrolyte. In some embodiments, the solid electrolyte is configured such that it serves to provide an environment with negative charge character, for example an oxidic environment that can stabilize cations of the metal M, for example in the +I and/or +II states, e.g. M⁺ ions. In some embodiments, the solid electrolyte comprises or consists of a material that has negative partial charges that can e.g. stabilize cations of the metal M, for example in the +I and/or +II states, e.g. M⁺ ions, for example oxides. In some embodiments, the solid electrolyte stabilizes a cation of the metal M, e.g. M⁺.

In some embodiments, an electrode comprises a solid electrolyte and a metal M, where the metal M is selected from Cu, Ag, Au, Pd, and mixtures and/or alloys thereof. The metal M may be selected from Cu, Ag and mixtures and/or alloys thereof. In some embodiments, the metal M serves both as catalyst and as electron conductor in the electrode of the invention. In some embodiments, the metal M is selected from Cu, Ag, Au, Pd, and mixtures and/or alloys thereof. The metal M may be Cu, Ag and mixtures and/or alloys thereof.

The concentration of metal in the electrode of the invention may be from a few per mille, e.g. 1, 5 or 10 per mille, up to the saturation limit of the metal M in the solid electrolyte. High concentrations of metal M may help form the active catalyst. In some embodiments, the proportion of metal M in the mixture of solid electrolyte and metal M is 10-60% by volume, e.g. 15-55% by volume, or 20-50% by volume, based on the volume of solid electrolyte and metal M.

In some embodiments, the metal M in the electrode is present both as elemental metal M, e.g. in the form of conductor tracks, and in cationic form, e.g. as M⁺ and/or M²⁺ (especially Pd) in the operation of the electrode, for example for reduction of CO₂ and/or CO. In the case of inward diffusion here, the metal, however, is usually 0-valent to ensure electrical neutrality. Since the system is conductive, the metal may also be in partly dissociated form, for example as M⁺+e⁻. In an integral sense, however, the charge on the metal in such cases is also again 0. In a formal sense, the metal M in the solid electrolyte or solid electrolyte matrix, as an overall average, especially in a chalcogenidic solid electrolyte, for example a glass, for example an oxidic matrix, after the activation, can thus be stabilized in an oxidation state between 0 and the valency of the cation, e.g. +1 and/or +2, for example between 0 and +1 for copper and/or silver.

Corresponding activation of the metal M in the electrode for production of cations, and also for production of conductor tracks, can be effected, for example, by applying an appropriate voltage after the metal M is applied to and diffuses into the solid electrolyte, or the solid electrolyte is added to a salt solution of the metal M and the metal M is deposited on and diffuses into the solid electrolyte by reduction, or a solid electrolyte is deposited onto an electrode comprising the metal M, or the solid electrolyte is deposited onto particles of the metal M and the particles have been processed further to give an electrode.

It has especially been found that the metal M, especially elemental silver or somewhat heavier elemental copper, especially in glasses of germanium chalcogenides such as germanium disulfide, germanium diselenide, but also tungsten trioxide, as solid electrolyte matrix dissolve even in the event of slight heating or incidence of light at room temperature, e.g. 20-25° C., such as about 22° C. for example, and, for example, normal room lighting (≤1000 lux, e.g. ≤500 lux) can be sufficient. It is positively sucked in. After production of the electrodes or application of the electrodes to a substrate and application of a potential, according to the polarity, highly conductive silver or copper structures can form in the chalcogenide matrix.

The effect is even observed for copper dissolved in a silicon dioxide matrix, such that a multitude of solid electrolytes, especially chalcogenidic matrix materials or mixtures thereof, become possible. These solid-state electrolytes can stabilize the oxidation states of metal M(0), e.g. Ag(0) or Cu(0), and metal M(+1) and/or (+2), e.g. Ag(+1) or Cu(+1). Both are especially necessary and important for the catalysis cycle of the one-stage electrochemical reduction of CO₂, for example when the electrode of the invention takes the form of a gas diffusion electrode.

In some embodiments, the electrode is a gas diffusion electrode. The gas diffusion electrode here is not particularly restricted, provided that, as usual in the case of gas diffusion electrodes, three states of matter—solid, liquid and gaseous—can be in contact with one another and the solid matter of the electrode has at least one electron-conducting catalyst capable of catalyzing an electrochemical reaction between the liquid phase and the gaseous phase.

In some embodiments, there are hydrophobic channels and/or pores or regions and possibly hydrophilic channels and/or pores or regions on the electrolyte side in the gas diffusion electrode (GDE), where catalyst sites may be present in the hydrophilic regions. On a side of the gas diffusion electrode, this may comprise hydrophobic channels and/or pores. In this respect, the gas diffusion electrode may comprise at least two sides, one with hydrophilic and optionally hydrophobic regions and one with hydrophobic regions.

Particularly active catalyst sites in a GDE lie in the liquid/solid/gaseous three-phase region. An ideal GDE thus has maximum penetration of the bulk material with hydrophilic and hydrophobic channels and/or pores in order to obtain a maximum number of three-phase regions for active catalyst sites.

As well as the metal M and the solid electrolyte, the electrode may also comprise further constituents, for example a substrate to which the solid electrolyte and the metal M may be applied, and/or at least one binding agent/binder. The substrate here is not particularly restricted and may comprise, for example, a metal such as silver, platinum, nickel, lead, titanium, nickel, iron, manganese, copper or chromium or alloys thereof, such as stainless steels, and/or at least one nonmetal such as carbon, Si, boron nitride (BN), boron-doped diamond, etc., and/or at least one conductive oxide such as indium tin oxide (ITO), aluminum zinc oxide (AZO) or fluorinated tin oxide (FTO)—for example for production of photoelectrodes, and/or at least one polymer based on polyacetylene, polyethoxythiophene, polyaniline or polypyrrole, as, for example, in polymer-based electrodes. In particular embodiments, however, the substrate may be formed essentially by the solid electrolyte and the metal M, optionally with at least one binder.

The binding agent or binder for the electrode, if present, is not particularly restricted and includes, for example, a hydrophilic and/or hydrophobic polymer, for example a hydrophobic polymer, especially PTFE (polytetrafluoro-ethylene). This can achieve a suitable adjustment of the hydrophobic pores or channels. More particularly, the gas diffusion electrode can be produced using PTFE particles having a particle diameter between 5 and 95 μm, e.g. between 8 and 70 μm. Suitable PTFE powders include, for example, Dyneon® TF 9205 and Dyneon TF 1750. Suitable binder particles, for example PTFE particles, may, for example, be approximately spherical, for example spherical, and may be produced, for example, by emulsion polymerization. In some embodiments, the binder particles are free of surface-active substances. The particle size can be determined here, for example, according to ISO 13321 or D4894-98a and may correspond, for example, to the manufacturer data (e.g. TF 9205: average particle size 8 μm to ISO 13321; TF 1750: average particle size 25 μm to ASTM D4894-98a).

In some embodiments, the electrode, especially as gas diffusion electrode, comprises or consists of solid electrolyte, metal M and binder.

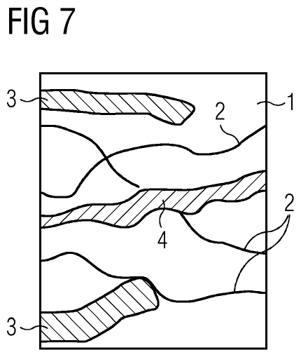

FIG. 7 shows a schematic detail from an example embodiment comprising an electrode in the form of a gas diffusion electrode, especially in a hydrophilic region. The electrode here comprises the solid electrolyte 1, for example germanium disulfide and/or germanium diselenide, as matrix, in which, as a result of activation, for example by application of a potential, conductor tracks of the metal M have formed, for example in the form of silver (Ag) 2. In addition, the GDE also has pores 3 and channels 4 through which electrolyte and/or gas, e.g. CO₂, can penetrate. As shown in the figure, the silver 2 may also lie on pores 3 and/or channels 4, where, as a result of the solid electrolyte matrix 1, it may be stabilized in the form of cations and hence catalytically activated. In some embodiments, the metal M has a solubility in the solid electrolyte at a temperature of 25° and standard pressure of at least 0.1 mol/L, e.g. greater than 1 mol/L.

In some embodiments, there is a method of electrolysis of CO₂ and/or CO, wherein the electrode describe herein is used as cathode, especially as gas diffusion electrode. The method of electrolysis of CO₂ and/or CO is not particularly restricted beyond that, especially with regard to the second half-cell in the electrolysis, the supply of reactants, the supply and removal of electrolyte, the removal of products, the construction of the electrolysis cell or electrolysis system, etc.

In some embodiments, there is a process for producing an electrode comprising a solid electrolyte and a metal M, wherein the metal M is selected from Cu, Ag, Au, Pd, and mixtures and/or alloys thereof, wherein the metal M is applied to and diffuses into the solid electrolyte, or wherein the solid electrolyte is added to a salt solution of the metal M and the metal M is deposited on and diffuses into the solid electrolyte by reduction, or wherein a solid electrolyte is deposited onto an electrode comprising the metal M, or wherein the solid electrolyte is deposited onto particles of the metal M and the particles are processed further to give an electrode. Even when a solid electrolyte is being deposited onto an electrode comprising the metal M, or when the solid electrolyte is being deposited onto particles of the metal M and the particles are being processed further to give an electrode, the metal M can be diffused into the solid electrolyte. The inward diffusion here is matched to the respective solid electrolyte and the metal M and is not restricted any further.

In some embodiments, the inward diffusion is conducted at a temperature of 20-100° C., 20-50° C., room temperature, 20-25° C., such as about 22° C. for example, for example by normal room lighting, and/or, for example, with a mercury vapor lamp, etc., for example with 1000 lux, e.g. 500 lux, for example when the solid electrolyte used is a chalcogen-based solid electrolyte, especially a glass of germanium chalcogenides such as germanium disulfide or germanium diselenide, or else of tungsten oxide, and especially when the metal M is silver, or when the solid electrolyte is silicon dioxide and the metal M is copper. The inward diffusion can also be effected by thermal means at a temperature of 30-100° C., e.g. 40-70° C.

In some embodiments, it is possible to prepare the solid electrolytes, especially chalcogenide-containing solid electrolytes, e.g. germanium chalcogenides, directly from the elements. For example, in the case of germanium chalcogenide, in a quartz glass ampoule, germanium and the chalcogenide are fused together at 700-1000° C. After the cooling, the solid material is ground and coated with the metal in a fluidized bed reactor. Production for other solid electrolytes can be effected analogously by known methods.

In some embodiments, the solid electrolyte is deposited on particles of the metal M and the particles are processed further to give an electrode. In some embodiments, the solid electrolyte is deposited on particles of the metal M, and the particles are processed further to give an electrode, where the particles of the metal M are nano- and/or microparticles, e.g. having a particle size of 10 nm to 500 μm. The particle size can be determined here, for example, by microscopy by means of image analysis, by laser diffraction and/or by dynamic light scattering. In some embodiments, the particles on which the solid electrolyte has been deposited are heat-treated, for example at a temperature between 20 and 350° C., e.g. between 40 and 300° C.

In some embodiments, the solid electrolyte is added to a salt solution of the metal M and the metal M is deposited on the solid electrolyte by reduction. The metal M here is not particularly restricted, provided that it is soluble in the solvent used, for example based on water or water, or based on an organic solvent. For example, silver can be deposited from an ammoniacal solution with the aid of formaldehyde or glucose as reducing agent.

In some embodiments, the metal M is applied to and diffuses into the solid electrolyte, or the solid electrolyte is added to a salt solution of the metal M and the metal M is deposited on and diffuses into the solid electrolyte by reduction, wherein the inward diffusion is effected by the action of heat and/or light.

In some embodiments, the metal M, e.g. silver and/or copper, is vapor-deposited onto and diffuses into a solid electrolyte powder, where the solid electrolyte powder is not particularly restricted. The solid electrolyte powder may, for example, comprise or consist of particles having a particle diameter between 0.1 and 200 μm, e.g. between 1 and 10 μm. The particle size can be determined here, for example, by microscopy by means of image analysis, by laser diffraction and/or by dynamic light scattering.

In some embodiments, a solid electrolyte is deposited onto an electrode comprising the metal M, especially when the electrode is a gas diffusion electrode. The deposition of the solid electrolyte is not particularly restricted here and can be effected, for example, from the gas phase or from solution, for example in an organic solvent.

In some embodiments, the metal M in the electrode is at least partly activated. A corresponding activation of the metal M in the electrode for production of cations, as also for production of conductor tracks, can be effected, for example, by applying an appropriate potential after the metal M is applied to and diffuses into the solid electrolyte, or the solid electrolyte is added to a salt solution of the metal M and the metal M is deposited on and diffuses into the solid electrolyte, or a solid electrolyte is deposited onto an electrode comprising the metal M, or the solid electrolyte is deposited onto particles of the metal M and the particles have been processed further to give an electrode. The correspondingly applied potential may be matched here, for example, to the solid electrolyte and/or the metal M.

The solid electrolyte catalysts produced, comprising solid electrolyte and metal M, may then be processed further by standard methods to give an electrode, for example by production of a powder with suitable particle size distribution, optionally addition of a binder powder, for example as specified above, and rolling to give an electrode, for example gas diffusion electrode.

In some embodiments, there is an electrolysis cell comprising an electrode, which is used as cathode. In some embodiments, the electrode in this electrolysis cell is a gas diffusion electrode. The further constituents of the electrolysis cell, for instance the anode, any membrane, feed(s) and drain(s), the voltage source, etc., and further optional devices such as cooling or heating units, are not particularly restricted, nor are anolytes and/or catholytes that are used in such an electrolysis cell, where the electrolysis cell, in particular embodiments, is used on the cathode side for reduction of carbon dioxide and/or CO. In some embodiments, the configuration of the anode space and of the cathode space is likewise not particularly restricted.

Examples of configurations for an illustrative construction of a typical electrolysis cell and of possible anode and cathode spaces are shown in FIGS. 1 to 4. An electrochemical reduction of, for example, CO₂ and/or CO takes place in an electrolysis cell that typically consists of an anode and a cathode space. FIGS. 1 to 4 below show examples of a possible cell arrangement. For each of these cell arrangements it is possible to use an electrode of the invention, for example as cathode.

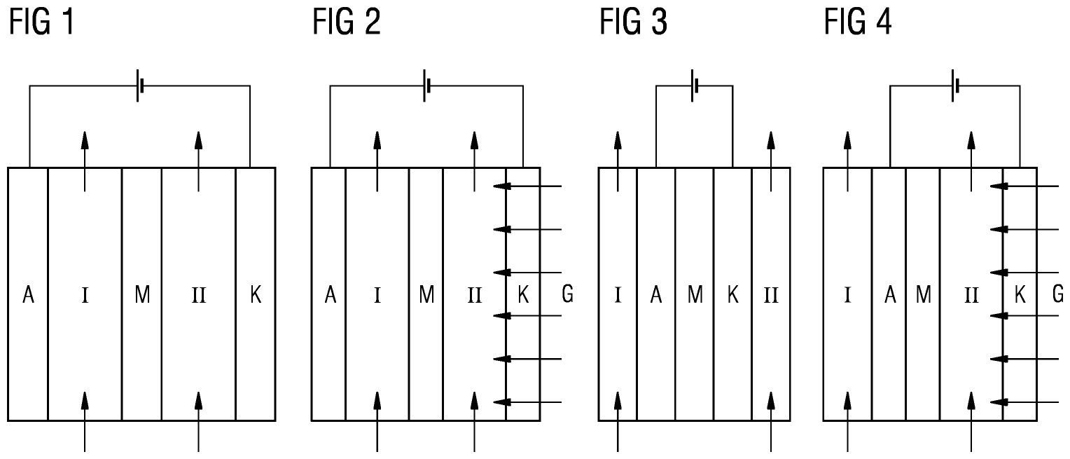

In some embodiments, the cathode space II (such as shown in FIG. 1) is configured such that a catholyte is supplied from the bottom, where this may contain a dissolved gas such as carbon dioxide and/or CO, and then leaves the cathode space II at the top. In some embodiments, the catholyte can also be supplied from the top, as, for example, in the case of falling-film electrodes. At the anode A, which is electrically connected to the cathode K by means of a power source for provision of the potential for the electrolysis, the oxidation of a substance which is supplied from the bottom, for example with an anolyte, takes place in the anode space I, and the anolyte then leaves the anode space together with the product of the oxidation. This 2-chamber construction differs from the 3-chamber construction in FIG. 2 in that a reaction gas, for example carbon dioxide or CO, can be conveyed into the cathode space II for reduction through a porous cathode such as a gas diffusion electrode.

Although they are not shown, embodiments with a porous anode are also conceivable. Both in FIG. 1 and in FIG. 2, the spaces I and II are separated by a membrane M. By contrast, in the PEM (proton or ion exchange membrane) construction of FIG. 3, a porous cathode K and a porous anode A directly adjoin the membrane M, which separates the anode space I from the cathode space II. The construction in FIG. 4 corresponds to a mixed form of the construction from FIG. 2 and the construction from FIG. 3, with provision on the catholyte side of a construction with a gas diffusion electrode, as shown in FIG. 2, whereas a construction as in FIG. 3 is provided on the anolyte side.

Of course, mixed forms or other configurations of the electrode spaces shown by way of example are also conceivable. Also conceivable are embodiments without a membrane. In some embodiments, the cathode-side electrolyte and the anode-side electrolyte may thus be identical, and the electrolysis cell/electrolysis unit need not have a membrane. However, it is not ruled out that the electrolysis cell, in such embodiments, has one or more membranes, for example 2, 3, 4, 5, 6 or more membranes, which may be the same or different, but this is associated with additional complexity with regard to the membrane and also the voltage applied. Catholyte and anolyte may optionally also be mixed again outside the electrolysis cell.

FIGS. 1 to 4 are schematic diagrams. The electrolysis cells from FIGS. 1 to 4 may also be combined to form mixed variants. For example, the anode space may be executed as a PEM half-cell, as in FIG. 3, while the cathode space consists of a half-cell containing a certain electrolyte volume between membrane and electrode, as shown in FIG. 1. In some embodiments, the distance between electrode and membrane is very small or 0 when the membrane is in porous form and includes a feed for the electrolyte. The membrane may also be in multilayer form, such that separate feeds of anolyte and catholyte are enabled. Separation effects in the case of aqueous electrolytes can be achieved, for example, by virtue of the hydrophobicity of interlayers and/or a corresponding adjustment of the prevailing capillary forces. Conductivity can nevertheless be assured when conductive groups are integrated into such separation layers. The membrane may be an ion-conductive membrane or a separator that brings about merely a mechanical separation and is permeable to cations and anions.

In some embodiments, the electrode comprises a gas diffusion electrode, which enables construction of a three-phase electrode. For example, a gas can be guided to the electrically active front side of the electrode from the back, in order to implement the electrochemical reaction there. In some embodiments, the flow may also merely pass by the gas diffusion electrode, meaning that a gas such as CO₂ and/or CO is guided past the reverse side of the gas diffusion electrode in relation to the electrolyte, in which case the gas can penetrate through the pores of the gas diffusion electrode and the product can be removed at the back. It has been found that, even though a gas such as CO₂ does not “bubble” through the electrolyte, high Faraday efficiencies (FE) of products are nevertheless found. For example, the gas flow in the case of flow-by is also reversed relative to the flow of the electrolyte in order that any liquid forced through can be transported away. In this case too, a gap between the gas diffusion electrode and the membrane is advantageous as electrolyte reservoir.

The supply of a liquid or solution containing a gas or the supply of a gas can additionally also be accomplished in another way for the gas diffusion electrode shown in FIG. 3, for example in the case of supply of CO₂. By virtue of the gas, e.g. CO₂, being guided through the electrode in a controlled manner, it is again possible to rapidly discharge the reduction products.

In some embodiments, the electrolysis cell has a membrane that separates the cathode space and the anode space of the electrolysis cell in order to prevent mixing of the electrolytes. The membrane is not particularly restricted here, provided that it separates the cathode space and the anode space. More particularly, it essentially prevents passage of the gases formed at the cathode and/or anode to the anode space or cathode space. In some embodiments, it comprises an ion exchange membrane, for example a polymer-based ion exchange membrane. An example material for an ion exchange membrane is a sulfonated tetrafluoroethylene polymer such as Nafion®, for example Nafion® 115. As well as polymer membranes, it is also possible to use ceramic membranes, for example those mentioned in EP 1685892 A1 and/or zirconia-laden polymers, e.g. polysulfones.

Similarly, the material of the anode is not particularly restricted and depends primarily on the desired reaction. Illustrative anode materials include platinum or platinum alloys, palladium or palladium alloys and glassy carbon. Further anode materials are also conductive oxides such as doped or undoped TiO₂, indium tin oxide (ITO), fluorine-doped tin oxide (FTO), aluminum-doped zinc oxide (AZO), iridium oxide, etc. These catalytically active compounds may optionally also merely be applied to the surface using thin-film technology, for example on a titanium and/or carbon carrier.

An abstract diagram of an illustrative apparatus of an electrolysis system is shown in FIG. 5. FIG. 5 shows, by way of example, an electrolysis in which carbon dioxide is reduced on the cathode side and water is oxidized on the anode A side, although other reactions also proceed, for example on the anode side. On the anode side, in further examples, it would be possible for a reaction of chloride to give chlorine, bromide to give bromine, sulfate to give peroxodisulfate (with or without evolution of gas), etc. to take place. Examples of suitable anodes A are platinum or iridium oxide on a titanium carrier, and an example of a cathode K is an electrode of the invention. The two electrode spaces of the electrolysis cell are separated by a membrane M, for example of Nafion®. The incorporation of the cell into a system with anolyte circuit 10 and catholyte circuit 20 is shown in schematic form in FIG. 5.

On the anode side, in this illustrative embodiment, water with electrolyte additions is fed into an electrolyte reservoir vessel 12 via an inlet 11. However, it is not impossible that water is supplied additionally or instead of the inlet 11 at another point in the anolyte circuit 10, since, according to FIG. 5, the electrolyte reservoir vessel 12 is also used for gas separation. The water is pumped out of the electrolyte reservoir vessel 12 by means of the pump 13 into the anode space, where it is oxidized. The product is then pumped back into the electrolyte reservoir vessel 12, where it can be led off into the product gas vessel 14. The product gas can be removed from the product gas vessel 14 via a product gas outlet 15. It is of course also possible for the product gas to be separated off elsewhere, for example in the anode space as well. The result is thus an anolyte circuit 10 since the electrolyte is circulated on the anode side.

On the cathode side, in the catholyte circuit 20, carbon dioxide is introduced via a CO₂ inlet 22 into an electrolyte reservoir vessel 21, where it is physically dissolved for example. By means of a pump 23, this solution is brought into the cathode space, where the carbon dioxide is reduced at the cathode K. An optional further pump 24 then pumps the solution obtained at the cathode K further to a vessel for gas separation 25, where a product gas can be led off into a product gas vessel 26. The product gas can be removed from the product gas vessel 26 via a product gas outlet 27. The electrolyte is in turn pumped out of the vessel for gas separation back to the electrolyte reservoir vessel 21, where carbon dioxide can be added again.

Here too, merely an illustrative arrangement of a catholyte circuit 20 is specified, and the individual apparatus components of the catholyte circuit 20 may also be arranged differently, for example in that the gas separation is effected at an early stage in the cathode space. E.g., the gas separation and gas saturation are effected separately, meaning that the electrolyte is saturated with CO₂ in one of the vessels and then is pumped through the cathode space as a solution without gas bubbles. The gas that leaves the cathode space may then, in some embodiments, consist to a predominant degree of product gas since CO₂ itself remains dissolved since it has been consumed, and hence the concentration in the electrolyte is somewhat lower.

The electrolysis is effected in FIG. 5 by addition of current via a current source (not shown). In order to be able to control the flow of the water and of the CO₂ dissolved in the electrolyte, valves 30 may optionally be introduced in the anolyte circuit 10 and catholyte circuit 20. The valves 30 are shown in the figure upstream of the inlet into the electrolysis cell, but may also be provided, for example, downstream of the outlet from the electrolysis cell and/or elsewhere in the anolyte circuit or catholyte circuit. It is also possible, for example, for a valve 30 to be upstream of the inlet into the electrolysis cell in the anolyte circuit, while the valve in the catholyte circuit is beyond the electrolysis cell, or vice versa.

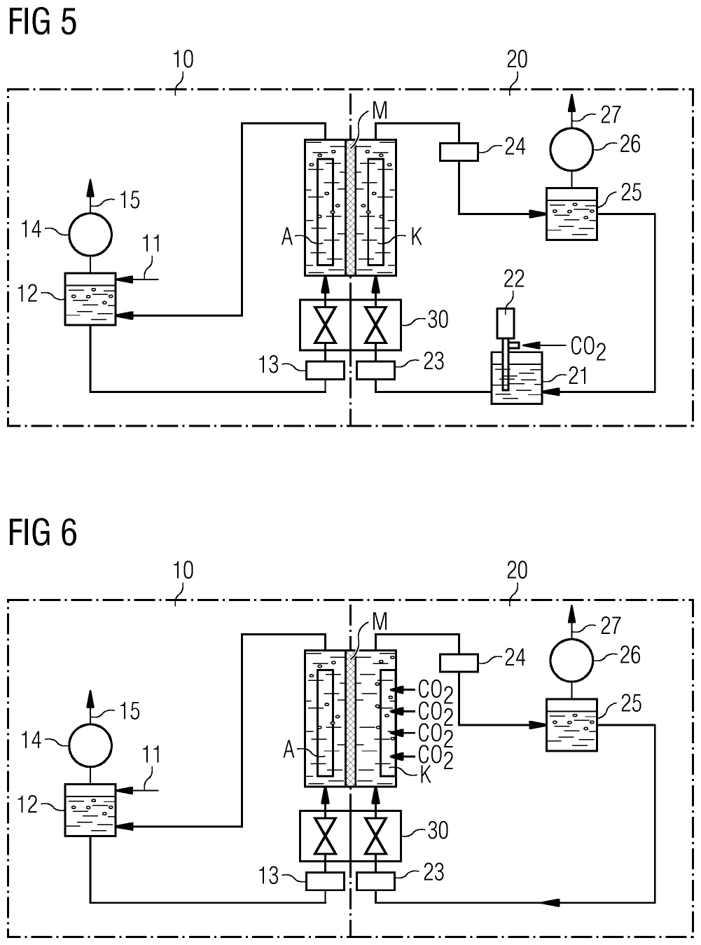

A further abstract diagram of an illustrative apparatus of an electrolysis system is shown in FIG. 6. The apparatus in FIG. 6 corresponds here to that of FIG. 5, with introduction of the addition of carbon dioxide into an electrolyte reservoir vessel 21 not via a CO₂ inlet 22, but directly via the cathode which is configured here as a gas diffusion electrode. In this case, the CO₂ can be supplied, for example, by flow-by or flow-through of a porous cathode.

The composition of a liquid or solution, for example an electrolyte solution, which is supplied to the electrolysis unit is not particularly restricted here, and may include all possible liquids or solvents, for example water in which electrolytes such as conductive salts, ionic liquids, substances for electrolytic conversion such as carbon dioxide, which may be dissolved in water for example, additives for improving the solubility and/or wetting characteristics, defoamers, etc. may optionally additionally be present. The catholyte may include carbon dioxide for example.

The liquids or solvents, any additional electrolytes such as conductive salts, ionic liquids, substances for electrolytic conversion, additives for improving solubility and/or wetting characteristics, defoamers, etc. may be present at least in one electrode space or in both electrode spaces. It is also possible in each case for two or more of the substances or mixtures thereof mentioned to be included. These are not particularly restricted in accordance with the invention and may be used on the anode side and/or on the cathode side.

The electrolysis cell or the electrolysis system may be used, for example, in an electrolysis of carbon dioxide and/or CO. The above embodiments, configurations and developments can, if viable, be combined with one another as desired. Further possible configurations, developments and implementations of the invention also include combinations that have not been mentioned explicitly of features that have been described above or are described hereinafter with regard to the working examples. More particularly, the person skilled in the art will also add individual aspects to the respective basic form of the present invention as improvements or supplementations. The disclosure is elucidated further in detail hereinafter with reference to various examples thereof. However, the scope thereof is not limited to these examples.

### Examples

Germanium disulfide is first synthesized in a quartz ampoule at 1100° C. from germanium and sulfur in a stoichiometric ratio of 1:2. Typical laboratory batches are in the range of 10-30 g.

Germanium disulfide powder is ground in a mill to the range of 1-20 μm, metalized with Ag powder having a particle diameter of 0.1-5 μm in a fluidized bed reactor and simultaneously illuminated. In the course of this, Ag is positively sucked in by the germanium disulfide. The Ag-infused germanium disulfide powder is processed with polytetrafluoroethylene as binder (1-20% by weight) to give a gas diffusion electrode. This is done by rolling the powder obtained onto a silver mesh.

Further gas diffusion electrodes are produced by replacing portions (5-80% by weight) of the Ag⁺ catalyst with silver powder in order to adjust the conductivity and Faraday efficiencies with regard to CO in the CO₂ electrolysis.

Electrification of the chemical industry means replacing processes that have been conducted by conventional thermal methods to date with electrochemical processes. For example, in a single electrochemical step in aqueous media, CO can be efficiently prepared from CO₂ over silver-based electrodes with silver as metal M over the novel catalysts of the invention.

Competing hydrogen formation can be suppressed by mixing metal cations such as Ag⁺ into the gas diffusion electrode. Silver oxide or corresponding compounds of the metal M can, however, be reduced to silver or metal M under operating conditions. This corresponds in principle to the standard procedure of activation of a gas diffusion electrode.

In order to avoid this reduction, then, the metal catalysts, e.g. silver or copper catalysts, are embedded into a solid-state electrolyte matrix. These solid-state electrolyte catalysts are then processed further by the standard methods to give a gas diffusion electrode, or already manufactured gas diffusion electrodes can be modified in this way.

What is claimed is:

1. An electrode comprising:
a solid electrolyte; and
a metal M selected from the group of metals consisting of: Cu, Ag, Au, and Pd;
wherein the solid electrolyte comprises a compound selected from the group consisting of: germanium disulfide, germanium diselenide, germanium sulfide, germanium selenide, tungsten trioxide, silver(I) sulfide, silicon dioxide, yttrium-stabilized zirconium(IV) oxide, polysulfone, polybenzoxazole, and polyimide.

2. The electrode as claimed in claim 1, wherein the electrode comprises a gas diffusion electrode.

3. The electrode as claimed in claim 1, wherein the solid electrolyte comprises at least one of: germanium disulfide, germanium diselenide, germanium sulfide, or germanium selenide.

4. The electrode as claimed in claim 1, wherein the metal M has a solubility of at least 0.1 mol/L in the solid electrolyte at a temperature of 25° and standard pressure.

5. The electrode as claimed in claim 1, wherein the solid electrolyte stabilizes a cation of the metal M.

6-7. (canceled)

8. A method for producing an electrode, the method comprising:
applying a metal M to a solid electrolyte; or
adding a solid electrolyte to a salt solution of a metal M so the metal M is deposited on and diffuses into the solid electrolyte by reduction; or
depositing a solid electrolyte onto an electrode comprising a metal M; or
depositing a solid electrolyte onto particles of a metal M to give an electrode;
wherein the solid electrolyte is selected from the group consisting of: germanium disulfide, germanium diselenide, germanium sulfide, germanium selenide, tungsten trioxide, silver(I) sulfide, silicon dioxide, yttrium-stabilized zirconium(IV) oxide, polysulfone, polybenzoxazole, and polyimide; and
the metal M is selected from the group of metals consisting of: Cu, Ag, Au, and Pd.

9. The process as claimed in claim 8, wherein the solid electrolyte is deposited on particles of the metal M and the particles are processed further to give an electrode, wherein the particles of the metal M are nano- and/or microparticles.

10. The process as claimed in claim 9, wherein the particles on which the solid electrolyte has been deposited are heat-treated.

11. The process as claimed in claim 8, wherein the metal M is applied to and diffuses into the solid electrolyte, or wherein the solid electrolyte is added to a salt solution of the metal M and the metal M is deposited on and diffuses into the solid electrolyte by reduction, wherein the inward diffusion is effected by the action of heat and/or light.

12. An electrolysis cell comprising:
an electrode comprising:
a solid electrolyte; and
a metal M selected from the group of metals consisting of: Cu, Ag, Au, and Pd;
wherein the solid electrolyte comprises a compound selected from the group consisting of: germanium disulfide, germanium diselenide, germanium sulfide, germanium selenide, tungsten trioxide, silver(I) sulfide, silicon dioxide, yttrium-stabilized zirconium(IV) oxide, polysulfone, polybenzoxazole, and polyimide.

13. (canceled)
